(19) United States
(12) Patent Application Publication
(10) Pub. No.: US 2013/0222346 A1
(43) Pub. Date: Aug. 29, 2013

(54) OPTICAL TOUCH DEVICE AND DETECTION METHOD THEREOF

(71) Applicant: PixArt Imaging Inc., (US)

(72) Inventors: Hsin-Chia CHEN, Hsin-Chu (TW); Hui-Hsuan CHEN, Hsin-Chu (TW); Cheng-Kuang SUN, Hsin-Chu (TW); Ming-Tsan KAO, Hsin-Chu (TW)

(73) Assignee: PIXART IMAGING INC., Hsin-Chu County (TW)

(21) Appl. No.: 13/739,566

(22) Filed: Jan. 11, 2013

(30) Foreign Application Priority Data
Feb. 29, 2012 (TW) 101106481

(51) Int. Cl. G06F 3/042

(52) U.S. Cl. CPC G06F 3/0425
USPC 345/175

(57) ABSTRACT

There is provided an optical touch device including a light source, a light control unit, a light guide, an image sensor and a processing unit. The light control unit controls the light source to illuminate in different brightness values. The light guide has an incident surface, a touch surface and an ejection surface, wherein the light source emit incident light into the light guide through the incident surface, and a plurality of microstructures are formed inside of and/or on the ejection surface of the light guide to disperse the incident light toward the touch surface to become dispersed light. The image sensor receives reflected light ejecting from the ejection surface to generate image frames corresponding to the different brightness values of the light source. The processing unit calculates a differential image of the image frames to accordingly identify an operating state.

### CROSS REFERENCE TO RELATED APPLICATION

This application claims the priority benefit of Taiwan Patent Application Serial Number 101106481, filed on Feb. 29, 2012, the full disclosure of which is incorporated herein by reference.

### BACKGROUND

1. Field of the Disclosure

This disclosure generally relates to a human-machine interface device and, more particularly, to an optical touch device and a detection method capable of detecting a hovering object and a contact object.

2. Description of the Related Art

It is able to control a touch system without using a separated peripheral device such that the touch system has an excellent operational convenience and can be applied to various human-machine interface devices. An optical touch system generally employs an optical sensor configured to detect reflected light from a finger to accordingly identify a position or a gesture of the finger.

For example FIG. 1A shows a schematic diagram of a conventional optical touch device. The optical touch device 8 includes a light source 81, a light guide 82 and an optical sensor 83. The light source 81 emits incident light 811 into the light guide 82 through an incident surface 821 and the incident light 811 can propagate away from the incident surface 821 in the light guide 82 due to the total reflection. When a finger contacts a touch surface 822 of the light guide 82, the total reflection of the touch surface 822 is frustrated and a part of the incident light 811 can be reflected by the finger to become reflected light 812 ejecting from an ejection surface 823 of the light guide 82 and being received by the optical sensor 83. However, this kind of optical touch device 8 can only detect a finger in contact with the touch surface 822 but can not detect a hovering finger.

FIG. 1B shows a schematic diagram of another optical touch device disclosed in U.S. Publication No. 2009/0267919, entitled “Multi-touch position tracking apparatus and interactive system and image processing method using the same”. The optical touch device 9 also includes a light source 91, a light guide 92 and an optical sensor 93. The light source 91 emits incident light 911 through an incident surface 921 of the light guide 92, and a part of the incident light 911 propagates away from the incident surface 921 inside the light guide 92 due to the total reflection of the surface of the light guide 92. Dispersing structures are formed on the touch surface 922 of the light guide 92 to frustrate the total reflection of the touch surface 922 such that a part of the incident light 911 can eject from the light guide 92 through the touch surface 922. When a finger approaches the touch surface 922, light ejecting from the touch surface 922 can be reflected toward an ejection surface 923 of the light guide 92 to become reflected light 912 that is received by the optical sensor 93. In this manner, the optical touch device 9 is able to detect a hovering object.

According, the present disclosure further provides an optical touch device and a detection method thereof that can detect both a hovering object and a contact object and can eliminate the interference from ambient light.

### SUMMARY

It is an object of the present disclosure to provide an optical touch device and detection method thereof configured to detect an operating state of an object.

It is another object of the present disclosure to provide an optical touch device and detection method thereof that can eliminate the interference from ambient light.

The present disclosure provides an optical touch device including a light source, a light control unit, a light guide, an image sensor and a processing unit. The light control unit controls the light source to illuminate in different brightness values. The light guide has an incident surface, a touch surface and an ejection surface, wherein the light source emits incident light into the light guide through the incident surface and a plurality of microstructures are formed inside of and/or on the ejection surface of the light guide configured to disperse the incident light toward the touch surface to become dispersed light. The image sensor receives reflected light ejecting from the ejection surface to generate image frames corresponding to the different brightness values of the light source. The processing unit is configured to calculate a differential image of the image frames and identify an operating state according to the differential image.

The present disclosure further provides a detection method of an optical touch device. The optical touch device includes a light source, a light guide, an image sensor and a processing unit, wherein the light guide has an incident surface, a touch surface and an ejection surface, and a plurality of microstructures are formed inside of and/or on the ejection surface of the light guide. The detection method includes the steps of: using the light source to illuminate in a first brightness value and a second brightness value; using the image sensor to capture, at a sampling frequency, reflected light formed by incident light emitted into the light guide by the light source and then dispersed toward the touch surface by the microstructures and then ejecting from the ejection surface so as to generate a first image frame corresponding to the first brightness value and a second image frame corresponding to the second brightness value; using the processing unit to calculate a differential image of the first image frame and the second image frame; and using the processing unit to identify an operating state according to a comparison result of comparing the differential image with two thresholds.

The present disclosure further provides a detection method of an optical navigation device. The optical touch device includes a light source, a light guide, an image sensor and a processing unit, wherein the light guide has an incident surface, a touch surface and an ejection surface, and a plurality of microstructures are formed inside of and/or on the ejection surface of the light guide. The detection method includes the steps of: using the light source to illuminate in a first brightness value, a second brightness value and a third brightness value; using the image sensor to capture, at a sampling frequency, reflected light formed by incident light emitted into the light guide by the light source and then dispersed toward the touch surface by the microstructures and then ejecting from the ejection surface reflected by at least one object in front of the touch surface so as to generate a first image frame corresponding to the first brightness value, a second image frame corresponding to the second brightness value and a third image frame corresponding to the third brightness value; using the processing unit to calculate a first differential image of the first image frame and the third image frame and a second differential image of the second image frame and the third image frame; and using the processing unit to identify an operating state according to comparison results of comparing the first differential image and the second differential image with at least one threshold.

In the optical touch device of the present disclosure, the microstructures are formed on an opposite surface of the touch surface and/or inside the light guide rather than formed on the touch surface to be configured to disperse the incident light toward the touch surface to become dispersed light, wherein the microstructures may have any shape and may be convexes, irregularities or concaves formed by printing, spraying, etching, atomising or pressing process without any limitation. In other words, the light guide is non-zero order designed so as to form a dispersing light field decaying rapidly with distance in front of the touch surface. When an object enters the dispersing light field, the object can reflect reflected light toward the light guide to allow the image sensor in front of the ejection surface to detect the reflected light.

In the optical touch device of the present disclosure, it is to identify a hovering object or a contact object according to the differential image captured by the image sensor such that the interference from ambient light can be effectively eliminated thereby increasing the identification accuracy.

In the optical touch device and the detection method of the present disclosure, the reflected light ejecting from the ejection surface is formed by an object in front of the touch surface, which is approaching or touching the touch surface, reflecting the dispersed light dispersed by the microstructures to pass through the light guide.

### BRIEF DESCRIPTION OF THE DRAWINGS

Other objects, advantages, and novel features of the present disclosure will become more apparent from the following detailed description when taken in conjunction with the accompanying drawings.

FIGS. 1A and 1B show schematic diagrams of the conventional optical touch device.

FIGS. 2A-2C show schematic diagrams of the optical touch device according to embodiments of the present disclosure.

FIG. 3 shows a schematic diagram of the image capturing and the lighting of the light source in the optical touch device according to the embodiment of the present disclosure.

FIG. 4 shows a flow chart of the detection method of the optical touch device according to an embodiment of the present disclosure.

FIG. 5 shows a flow chart of the detection method of the optical touch device according to another embodiment of the present disclosure.

FIGS. 6A-6C show schematic diagrams of the differential image and the threshold in the embodiment of the present disclosure.

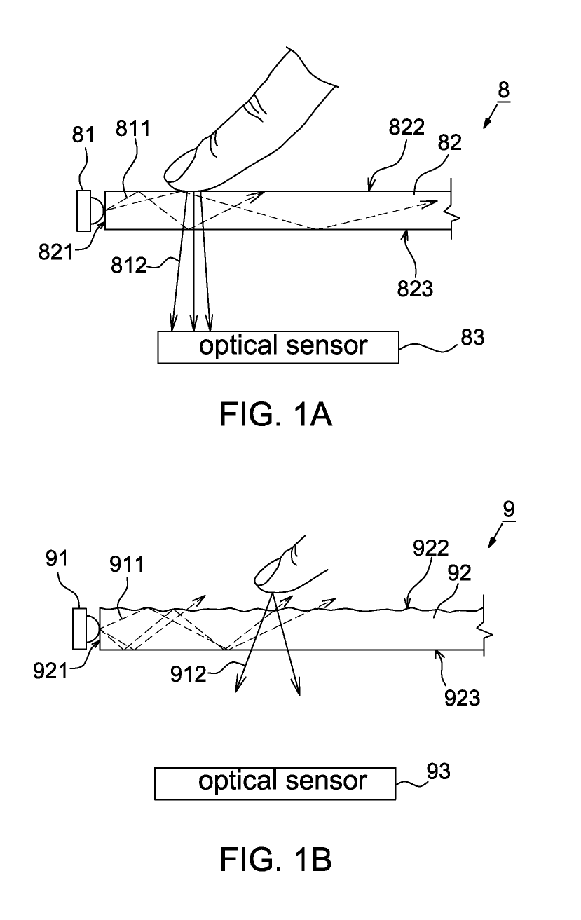

### DETAILED DESCRIPTION OF THE EMBODIMENT

It should be noted that, wherever possible, the same reference numbers will be used throughout the drawings to refer to the same or like parts.

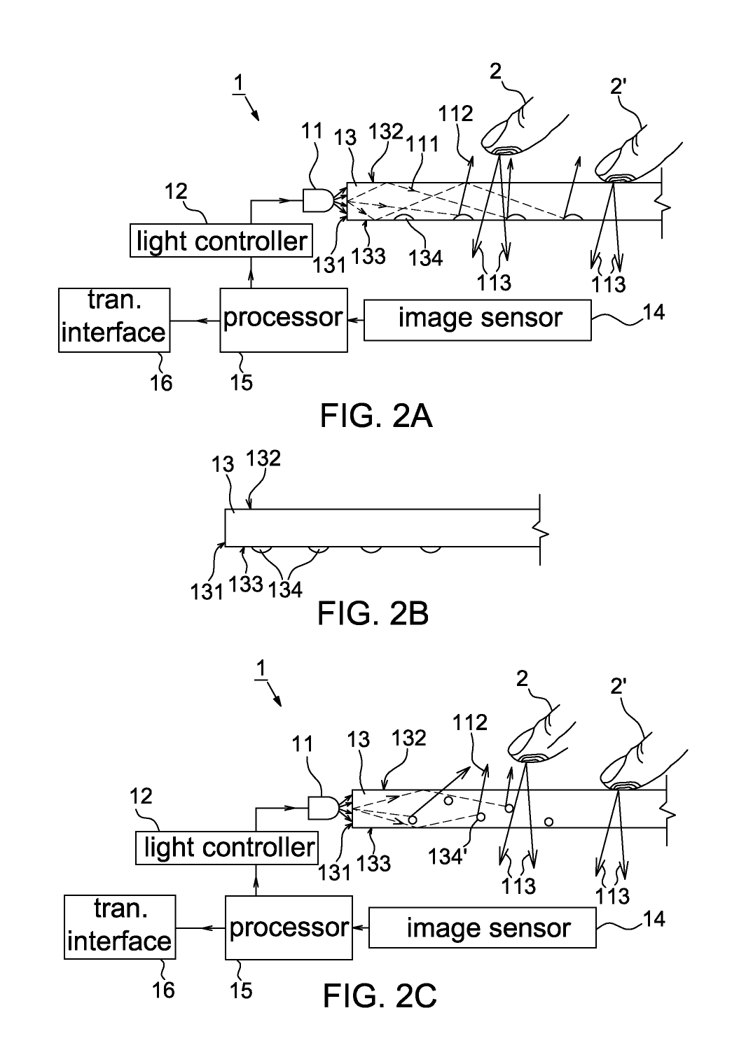

Referring to FIGS. 2A-2C, they show schematic diagrams of the optical touch device according to embodiments of the present disclosure. The optical touch device 1 is configured to detect an operating state of an object 2, wherein the object 2 may be a finger, a touch pen or other pointing devices without any limitation as long as it can reflect light emitted by a light source. Said operating state includes a hovering state, e.g. the object 2, and a contact state, e.g. the object 2′. In addition, the optical touch device 1 may be configured to perform multi-point touch control and is not limited to single touch control.

The optical touch device 1 of the present embodiment includes a light source 11, a light control unit 12, a light guide 13, an image sensor 14, a processing unit 15 and a transmission interface 16, wherein the light control unit 12 may be included in the processing unit 15 or independent from the processing unit 15 without any limitation.

The light source 1 is preferably a light emitting diode configured to emit infrared light, red light or other invisible light. The light source 11 is configured to emit incident light 111 into the light guide 13 through an incident surface 131 of the light guide 13 and the incident light 111 propagates away from the incident surface 131 inside the light guide 13. In other words, the light source 11 is disposed opposite to the incident surface 131.

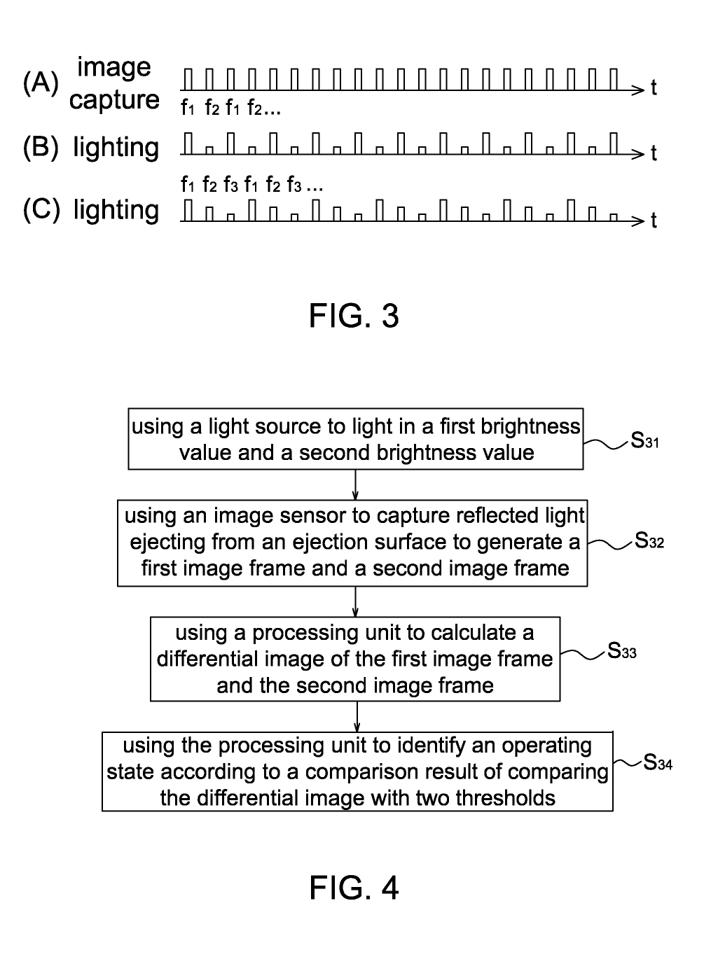

The light control unit 13 is configured to control the light source 11 to illuminate in different brightness values. The purpose of controlling the light source 11 to illuminate in different brightness values is to eliminate the interference from ambient light by calculating a differential image in the post-processing (described later). The light control unit 12 is controlled by the processing unit 15 to allow the lighting of the light source 11 to synchronize to the image capturing of the image sensor 14 as shown in FIG. 3.

The light guide 13 may be made of materials transparent to the light emitted by the light source 11, e.g. glass or plastic, but not limited thereto. The light guide 13 has the incident surface 131, a touch surface 132 and an ejection surface 133, wherein the touch surface 132 and the ejection surface 133 are opposite to each other. An object 2 is operated in front of the touch surface 132, wherein operable functions are similar to those of a general optical touch device and thus details thereof are not described herein. In this embodiment, a plurality of microstructures 134 are formed on the ejection surface 133 (e.g. inner surface or exterior surface) of the light guide 13 (as shown in FIGS. 2A and 2B) and/or a plurality of microstructures 134′ are formed inside the light guide 13 (as shown in FIG. 2C), wherein said microstructures 134 may have any shape and may be convexes, irregularities or concaves formed by the printing, spraying, etching, atomising or pressing process, and the microstructures 134′ may be formed by mixing air, oil or other materials inside the light guide 13 during manufacturing without any limitation as long as it is able to disperse the incident light 111 emitted by the light source 11. The microstructures 134 and 134′ are configured to disperse the incident light 111 toward the touch surface 132 to become dispersed light 112 that ejects from the light guide 13, and the dispersed light 112 is reflected by the object 2, 2′ in front of the touch surface 132 to become reflected light 113 and the reflected light 113 passes through the light guide 13 again to eject from the ejection surface 133. In this embodiment, an area ratio of a total area of the microstructures 134, 134′ and that of the ejection surface 133 is preferably within 10%-75% to allow the microstructures 134, 134′ to disperse enough incident light 111 and to allow enough reflected light 113 to eject from the ejection surface 133.

The image sensor 14 may be a CCD image sensor, a CMOS image sensor or other sensors configured to sense optical energy, and the image sensor 14 is disposed at a side of the ejection surface 133 and configured to receive and capture the reflected light 113 ejecting from the ejection surface 133 at a sampling frequency and to generate image frames corresponding to the different brightness values of the light source 11 (described later), and the image frames are transmitted to the processing unit 15 for post-processing.

The processing unit 15 calculates a differential image of the image frames and identifies the operating state according to the differential image.

The transmission interface 16 is configured to wired or wirelessly transmit the operating state to a related electronic device for corresponding control.

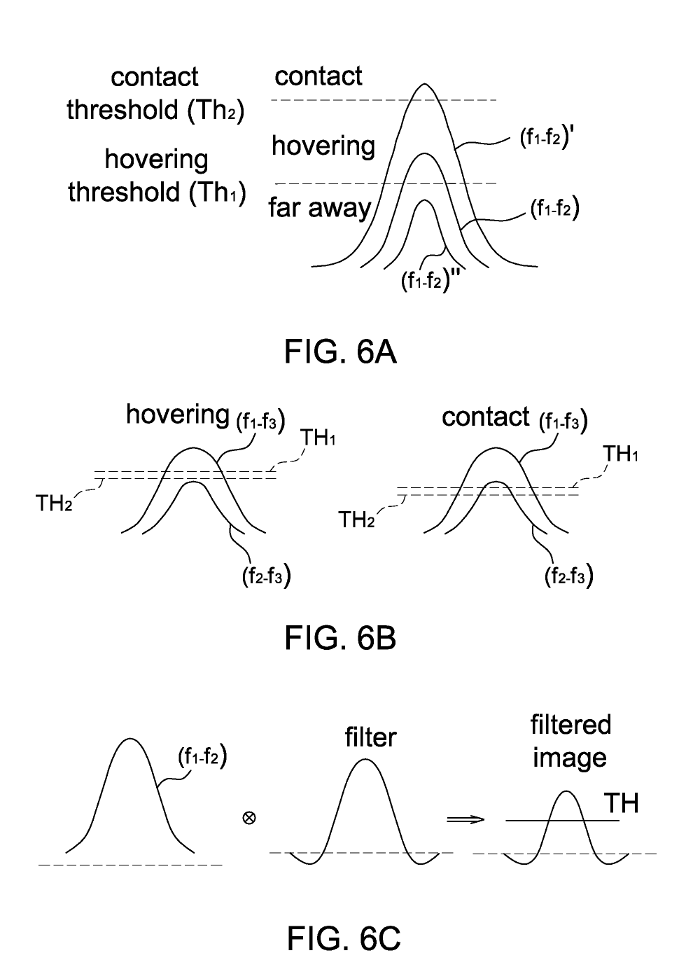

Referring to FIGS. 2A-2C, 3, 4 and 6A, FIG. 3 shows an operational schematic diagram of the image capturing and the lighting of the light source in the optical touch device 1 according to the embodiment of the present disclosure; FIG. 4 shows a flow chart of the detection method of the optical touch device 1 according to an embodiment of the present disclosure; and FIG. 6A shows a schematic diagram of the differential image and the threshold in the embodiment of the present disclosure. The detection method of the present embodiment includes the steps of: using a light source to illuminate alternatively in a first brightness value and a second brightness value (Step S₃₁); using an image sensor to capture, at a sampling frequency, reflected light formed by incident light emitted into the light guide by the light source and then dispersed toward the touch surface by the microstructures and then ejecting from the ejection surface so as to generate a first image frame corresponding to the first brightness value and a second image frame corresponding to the second brightness value (Step S₃₂); using a processing unit to calculate a differential image of the first image frame and the second image frame (Step S₃₂); and using the processing unit to identify an operating state according to a comparison result of comparing the differential image with two thresholds (Step S₃₄).

Step S₃₁: The light control unit 12 controls the light source 11 to illuminate alternatively in a first brightness value (e.g. rectangles having a longer length) and a second brightness value (e.g. rectangles having a shorter length) as shown in FIG. 3(B), wherein the first brightness value is larger than the second brightness value and the second brightness value may be zero brightness (i.e. turning off) or nonzero brightness.

Step S₃₂: The image sensor 14 captures, at a fixed sampling frequency, reflected light 113 formed by incident light 111 emitted into the light guide 13 by the light source 11 through the incident surface 131 and then dispersed toward the touch surface 132 by the microstructures 134, 134′ to eject from the touch surface 132 and then reflected by the object 2, 2′ to pass through the light guide 13 and to eject from the ejection surface 133 so as to generate a first image frame f₁ corresponding to the first brightness value and a second image frame f₂ corresponding to the second brightness value, and the image frames are sent to the processing unit 15 for post-processing, wherein as the first brightness value is larger than the second brightness value, an average intensity of the first image frame f₁ is larger than that of the second image frame f₂.

Step S₃₃: The processing unit 15 then calculates a differential image (f₁-f₂) of the first image frame f₁ and the second image frame f₂. As each of the image frames f1 and f2 captured by the image sensor 14 contains ambient light, the interference from the ambient light can be effectively eliminated by calculating the differential image (f₁-f₂).

Step S₃₄: The processing unit 15 identifies whether the object is in a hovering state or a contact state according to a comparison result of comparing the differential image (f₁-f₂) with a first threshold (e.g. a hovering threshold Th₁) and a second threshold (e.g. a contact threshold Th₂) as shown in FIG. 6A.

For example in one embodiment, when the pixel intensity of a part of pixel area or a maximum pixel intensity of a differential image (f₁-f₂) is larger than the first threshold Th₁ and smaller than the second threshold Th₂, it means that the object 2 already can be illuminated by the dispersed light 112 but is not in contact with the touch surface 132 and thus the object 2 is identified in a hovering state. When the pixel intensity of a part of image area or a maximum pixel intensity of a differential image (f₁-f₂)′ is larger than the second threshold Th₂, it means that the object 2′ is in contact with the touch surface 132 and reflects a large amount of the dispersed light 112 and thus the object 2′ is identified in a contact state. When the pixel intensity of all pixels or a maximum pixel intensity of a differential image (f₁-f₂)″ is smaller than the first threshold Th₁, it means that the object is neither in a hovering state nor in a contact state. In this embodiment, a part of the differential image (f₁-f₂) is compared with two thresholds.

In another embodiment, when an average pixel intensity of a differential image (f₁-f₂) is larger than the first threshold Th₁ and is smaller than the second threshold Th₂, the object 2 is identified in a hovering state. When an average pixel intensity of a differential image (f₁-f₂)′ is larger than the second threshold Th₂, the object 2′ is identified in a contact state. In this embodiment, the whole (i.e. average intensity) of the differential image (f₁-f₂) is compared with two thresholds.

Referring to FIGS. 2A-2C, 3, 5 and 6B, FIG. 5 shows a flow chart of the detection method of the optical touch device 1 according to another embodiment of the present disclosure; and FIG. 6B shows a schematic diagram of the differential image and the threshold in the embodiment of the present disclosure. The detection method of the present embodiment includes the steps of: using a light source to illuminate alternatively in a first brightness value, a second brightness value and a third brightness value (Step S₄₁); using an image sensor to capture, at a sampling frequency, reflected light formed by incident light emitted into the light guide by the light source and then dispersed toward the touch surface by the microstructures and then ejecting from the ejection surface so as to generate a first image frame corresponding to the first brightness value, a second image frame corresponding to the second brightness value and a third image frame corresponding to the third brightness value (Step S₄₂); using a processing unit to calculate a first differential image of the first image frame and the third image frame and a second differential image of the second image frame and the third image frame (Step S₄₃); and using the processing unit to identify an operating state according to comparison results of comparing the first differential image and the second differential image with at least one threshold (Step S₄₄).

Step S₄₁: The light control unit 12 controls the light source 11 to illuminate alternatively in a first brightness value (e.g. rectangles having the longest length) and a second brightness value (e.g. rectangles having the second longest length) and a third brightness value (e.g. rectangles having the shortest length) as shown in FIG. 3(C), wherein the first brightness value is larger than the second brightness value and the second brightness value is larger than the third brightness value, and the third brightness value may be zero brightness (i.e. turning off) or nonzero brightness.

Step S₄₂: The image sensor 14 captures, at a fixed sampling frequency, reflected light 113 formed by incident light 111 emitted into the light guide 13 by the light source 11 through the incident surface 131 and then dispersed toward the touch surface 132 by the microstructures 134, 134′ to eject from the touch surface 132 and then reflected by the object 2, 2′ to pass through the light guide 13 and to eject from the ejection surface 133 so as to generate a first image frame f₁ corresponding to the first brightness value, a second image frame f₂ corresponding to the second brightness value and a third image frame f₃ corresponding to the third brightness value, and the image frames are sent to the processing unit 15 for post-processing, wherein as the first brightness value is larger than the second brightness value and the second brightness value is larger than the third brightness value, an average intensity of the first image frame f₁ is larger than that of the second image frame f₂ and an average intensity of the second image frame f₂ is larger than that of the third image frame f₃.

Step S₄₃: The processing unit 15 then calculates a first differential image (f₁-f₃) of the first image frame f₁ and the third image frame f₃ and calculates a second differential image (f₂-f₃) of the second image frame f₂ and the third image frame f₃, and this step is also configured to eliminate the interference from ambient light.

Step S₄₄: The processing unit 15 identifies whether the object is in a hovering state or a contact state according to comparison results of comparing the first differential image (f₁-f₃) and the second differential image (f₂-f₃) with at least one threshold as shown in FIG. 6B.

For example in one embodiment, when the pixel intensity of a part of image area or a maximum pixel intensity of the first differential image (f₁-f₃) is larger than a first threshold TH₁ and the pixel intensity of all pixels or a maximum pixel intensity of the second differential image (f₂-f₃) is smaller than a second threshold TH₂, it means that the object 2 can be illuminated by a stronger dispersed light 112 but can not be illuminated by a weaker dispersed light 112 and thus the object 2 is identified in a hovering state (as shown in the left part of FIG. 6B). When the pixel intensity of a part of image area or a maximum pixel intensity of the second differential image (f₂-f₃) is larger than the second threshold TH₂, it means that the object 2′ can be illuminated by a weaker dispersed light 112 and thus the object 2′ is identified in a contact state (as shown in the right part of FIG. 6B), wherein the first threshold TH₁ may be identical to or different from the second threshold TH₂. In other words, in this embodiment at least a part of the first differential image (f₁-f₃) and the second differential image (f₂-f₃) is compared with a same threshold or compared with different thresholds respectively.

In another embodiment, when an average pixel intensity of the first differential image (f₁-f₃) is larger than a first threshold TH₁ and an average pixel intensity of the second differential image (f₂-f₃) is smaller than a second threshold TH₂, the object 2 is identified in a hovering state. When the average pixel intensity of the second differential image (f₂-f₃) is larger than the second threshold TH₂, the object 2′ is identified in a contact state, wherein the first threshold TH₁ may be identical to or different from the second threshold TH₂. In other words, in this embodiment the whole (i.e. average intensity) of the first differential image (f₁-f₃) and the second differential image (f₂-f₃) is compared with a same threshold or compared with different thresholds respectively.

In another embodiment, a differential image may be denoised at first, e.g. filtering the differential image to become a filtered differential image to reduce the interference from noise (e.g. using a low-pass filter) and the interference from ambient light (e.g. using a high-pass filter), and then a filtered maximum pixel intensity and/or a filtered average pixel intensity of the filtered differential image is compared with at least one threshold so as to identify an operating state. For example in FIG. 6C, convolution is performed on the differential image (f₁-f₂) and a filter so as to form a filtered differential image. It is appreciated that a spectrum of the filter is not limited to FIG. 6C and it may be determined according to actual applications.

In other words, in every embodiment of the present disclosure, a characteristic value of the differential image is compared with at least one threshold so as to identify the operating state, wherein the characteristic value may be a maximum pixel intensity, an average pixel intensity, a maximum pixel intensity of a filtered differential image and/or an average pixel intensity of a filtered differential image, but not limited thereto.

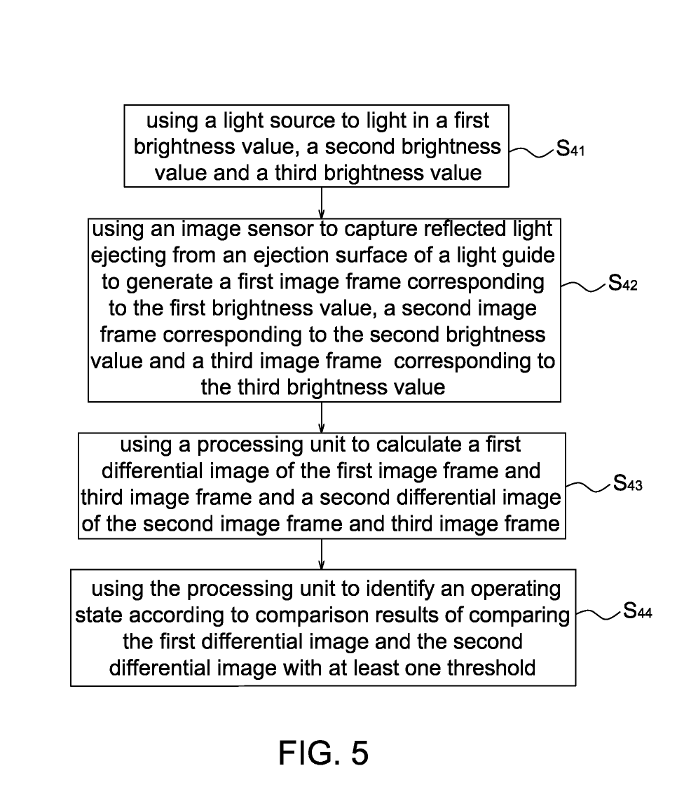

As mentioned above, in the light guide of a conventional optical touch device, dispersing structures are formed on a touch surface to frustrate total internal reflection of the touch surface such that light can eject from the touch surface. The present disclosure further provides an optical touch device (FIGS. 2A-2C) and a detection method thereof (FIGS. 4 and 5), wherein the touch surface is not formed with any structure configured to frustrate total internal reflection and the interference of ambient light is eliminated by calculating differential images.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. An optical touch device, comprising:
a light source;
a light control unit configured to control the light source to illuminate in different brightness values;
a light guide having an incident surface, a touch surface and an ejection surface, wherein the light source emits incident light into the light guide through the incident surface and a plurality of microstructures are formed inside of and/or on the ejection surface of the light guide configured to disperse the incident light toward the touch surface to become dispersed light;
an image sensor receiving reflected light ejecting from the ejection surface to generate image frames corresponding to the different brightness values of the light source; and
a processing unit configured to calculate a differential image of the image frames and identify an operating state according to the differential image.

2. The optical touch device as claimed in claim 1, wherein the light control unit controls the light source to illuminate in a first brightness value and a second brightness value; the image sensor generates a first image frame corresponding to the first brightness value and a second image frame corresponding to the second brightness value; the processing unit calculates a differential image of the first image frame and the second image frame; and the first brightness value is larger than the second brightness value.

3. The optical touch device as claimed in claim 2, wherein the processing unit further compares the differential image with a first threshold and a second threshold; a hovering state is identified when a characteristic value of the differential image is larger than the first threshold and smaller than the second threshold, and a contact state is identified when the characteristic value of the differential image is larger than the second threshold.

4. The optical touch device as claimed in claim 3, wherein the characteristic value is a maximum pixel intensity, an average pixel intensity, a filtered maximum pixel intensity or a filtered average pixel intensity.

5. The optical touch device as claimed in claim 2, wherein the second brightness value is zero brightness or nonzero brightness.

6. The optical touch device as claimed in claim 1, wherein the light control unit controls the light source to illuminate alternatively in a first brightness value, a second brightness value and a third brightness value; the image sensor generates a first image frame corresponding to the first brightness value, a second image frame corresponding to the second brightness value and a third image frame corresponding to the third brightness value; the processing unit calculates a first differential image frame of the first image frame and the third image frame and a second differential image frame of the second image frame and the third image frame, and the first brightness value is larger than the second brightness value and the second brightness value is larger than the third brightness value.

7. The optical touch device as claimed in claim 6, wherein the processing unit further compares the first differential image and the second differential image with a threshold; a hovering state is identified when a characteristic value of the first differential image is larger than the threshold and a characteristic value of the second differential image is smaller than the threshold, and a contact state is identified when the characteristic value of the second differential image is larger than the threshold.

8. The optical touch device as claimed in claim 7, wherein the characteristic value is a maximum pixel intensity, an average pixel intensity, a filtered maximum pixel intensity or a filtered average pixel intensity.

9. The optical touch device as claimed in claim 6, wherein the third brightness value is zero brightness or nonzero brightness.

10. The optical touch device as claimed in claim 1, wherein the reflected light ejecting from the ejection surface is formed by an object in front of the touch surface reflecting the dispersed light to pass through the light guide.

11. A detection method of an optical touch device, the optical touch device comprising a light source, a light guide, an image sensor and a processing unit, the light guide having an incident surface, a touch surface and an ejection surface, and a plurality of microstructures being formed inside of and/or on the ejection surface of the light guide, the detection method comprising:
using the light source to illuminate in a first brightness value and a second brightness value;
using the image sensor to capture, at a sampling frequency, reflected light formed by incident light emitted into the light guide by the light source and then dispersed toward the touch surface by the microstructures and then ejecting from the ejection surface so as to generate a first image frame corresponding to the first brightness value and a second image frame corresponding to the second brightness value;
using the processing unit to calculate a differential image of the first image frame and the second image frame; and
using the processing unit to identify an operating state according to a comparison result of comparing the differential image with two thresholds.

12. The detection method as claimed in claim 11, wherein a hovering state is identified when a characteristic value of the differential image is larger than a first threshold and smaller than a second threshold, and a contact state is identified when the characteristic value of the differential image is larger than the second threshold.

13. The detection method as claimed in claim 12, wherein the characteristic value is a maximum pixel intensity, an average pixel intensity, a filtered maximum pixel intensity or a filtered average pixel intensity.

14. The detection method as claimed in claim 11, wherein the second brightness value is zero brightness or nonzero brightness.

15. The detection method as claimed in claim 11, wherein the reflected light ejecting from the ejection surface is formed by an object in front of the touch surface reflecting the dispersed light to pass through the light guide.

16. A detection method of an optical touch device, the optical touch device comprising a light source, a light guide, an image sensor and a processing unit, the light guide having an incident surface, a touch surface and an ejection surface, and a plurality of microstructures being formed inside of and/or on the ejection surface of the light guide, the detection method comprising:
using the light source to illuminate in a first brightness value, a second brightness value and a third brightness value;
using the image sensor to capture, at a sampling frequency, reflected light formed by incident light emitted into the light guide by the light source and then dispersed toward the touch surface by the microstructures and then ejecting from the ejection surface so as to generate a first image frame corresponding to the first brightness value, a second image frame corresponding to the second brightness value and a third image frame corresponding to the third brightness value;
using the processing unit to calculate a first differential image of the first image frame and the third image frame and a second differential image of the second image frame and the third image frame; and
using the processing unit to identify an operating state according to comparison results of comparing the first differential image and the second differential image with at least one threshold.

17. The detection method as claimed in claim 16, wherein a hovering state is identified when a characteristic value of the first differential image is larger than a first threshold and a characteristic value of the second differential image is smaller than a second threshold, a contact state is identified when the characteristic value of the second differential image is larger than the second threshold, and the first threshold is identical to or different from the second threshold.

18. The detection method as claimed in claim 17, wherein the characteristic value is a maximum pixel intensity, an average pixel intensity, a filtered maximum pixel intensity or a filtered average pixel intensity.

19. The detection method as claimed in claim 16, wherein the third brightness value is zero brightness or nonzero brightness.

20. The detection method as claimed in claim 16, wherein the reflected light ejecting from the ejection surface is formed by an object in front of the touch surface reflecting the dispersed light to pass through the light guide.
